(19) United States
(12) Patent Application Publication
(10) Pub. No.: US 2006/0121325 A1
(43) Pub. Date: Jun. 8, 2006

(54) Energy-recovery method and device used on board a vehicle comprising a reformer fuel cell

(75) Inventors: Patrick Beguery, Fontenay Le Fleury (FR); Gilles Dewaele, Rueil Malmaison (FR); Fahri Keretll, Le Mesnil St-Denis (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: Renault S.A.S., Boulogne Billancourt (FR)

(21) Appl. No.: 10/528,706

(22) PCT Filed: Oct. 2, 2003
(86) PCT No.: PCT/FR03/02891

§ 371 Date: Nov. 8, 2005

(30) Foreign Application Priority Data
Oct. 3, 2002 (FR) 02/12258

(51) Int. Cl. H01M 8/04; H01M 8/06

(52) U.S. Cl. 429/23; 429/19; 429/13

(57) ABSTRACT

A method and device for recovering electrical energy in a motor vehicle driven by at least one electric motor. A fuel cell powers the electric motor, which is supplied with fuel by a reformer, the fuel flow being controlled according to power consumption of the electric motor, and which temporarily produces an excess of fuel when the consumption of the electric motor falls. Moreover, the device includes an energy storage. The method calculates excess electric power that can be produced by the fuel cell and stores and distributes the excess fuel, during which the excess electric power is stored in a storage.

The invention concerns a method of recovery of electric energy in a motor vehicle driven by at least one electric motor.

The invention concerns, more particularly, a method of recovery of electric energy in a motor vehicle driven by at least one electric motor, of the type containing a fuel cell which feeds the electric motor and electrical equipment and which is supplied with fuel, and notably hydrogen, by means of a reformer, the fuel flow of which is controlled in accordance with the electric power consumption of the electric motor, and which temporarily produces excess fuel when the consumption of the electric motor diminishes, and of the type containing energy storage means.

The vehicles driven by at least one electric motor can, notably, be supplied with electric energy by a fuel cell.

A fuel cell consists mainly of two electrodes, one anode and one cathode, which are separated by an electrolyte. That type of cell makes possible the direct conversion into electric energy of the energy produced by the following oxidation-reduction reactions:

an oxidation reaction of a fuel, which continuously feeds the anode; and

a reduction reaction of a fuel which continuously feeds the cathode.

The fuel cells used to supply electric energy on motor vehicles are generally of the solid electrolyte type, notably with polymer electrolyte. Such a cell notably uses hydrogen (H₂) and oxygen (O₂) as fuel and oxidizing agent respectively.

This type of cell makes it possible to obtain at the same time an efficiency, a reaction time and operating temperature by and large satisfactory for supplying electricity to an electric motor for driving a motor vehicle.

In contrast to thermal engines which emit a not negligible quantity of pollutant substances with the exhaust gases, the fuel cell offers, notably, the advantage of only emitting the water produced by the cathode reduction reaction. Furthermore, a cell of the type described above can use ambient air, the oxygen (O₂) of which is reduced.

The cathode generally contains an inlet which makes possible the continuous supply of oxygen (O₂) or air, and an outlet which makes possible evacuation of the surplus air or oxygen (O₂), as well as evacuation of the water produced on reduction of the oxygen (O₂). In general, the anode usually contains an inlet through which the hydrogen (H₂) is introduced.

However, in the present state of the art, the storage of pure hydrogen (H₂) in a vehicle requires too great a volume for comfortable autonomy. Furthermore, the logistics of distribution of hydrogen (H₂) is not yet widespread geographically.

To solve those problems, it is known to produce hydrogen (H₂) directly on the vehicle with hydrocarbons, notably conventional fuels such as gasoline or natural gas. The hydrogen (H₂) is extracted from gasoline in a so-called reforming operation which requires a device called a reformer.

The gasoline is injected into the reformer with water and air. The product of reforming is a gas called reformate, which is mainly composed of hydrogen (H₂), carbon monoxide (CO), carbon dioxide (CO₂), oxygen (O₂) and nitrogen (N₂). The reformer generally contains a burner which supplies the heat energy necessary to maintain the reformer at an operating temperature. The anode of the cell is then directly supplied with reformate by the reformer.

The electric power produced by the fuel cell is proportional to the flows of oxidizing agent and fuel injected into the cathode and anode respectively. To control the electric power that the cell must supply to the electric motor, it is therefore known to vary the flows of oxidizing agent and fuel feeding the cell. Thus, the flow of fuel injected into the anode is regulated by controlling the reformer.

However, the response time of the reformer between the instant at which a fuel flow variation is required in order to vary the current production of the fuel cell and the instant at which the fuel flow actually varies is on the order of several seconds.

Thus, when the electric motor requires greater electric power, the cell can supply the electric power required only after a response time of several seconds, the time for the reformer to produce the adequate reformate flow.

Likewise, when the motor requires less electricity, the reformer continues for a few second to produce a surplus flow of reformate which is not consumed by the fuel cell.

To overcome the temporary shortage of electric power due to the latency time of the reformer, when the motor requires a rapid increase of electricity, it is known to feed the electric motor temporarily with the aid of at least one auxiliary battery.

However, for reasons of cost, space required and weight, the number of auxiliary batteries should be as low as possible.

To limit the number of batteries installed in the vehicle, it is known to recover the energy on decelerations of the vehicle and to store that recovered energy in the batteries. Such a solution is, notably, described and represented in document EP-A-0,640,503.

That document proposes a method of recovery of the energy produced by the traction motor when the latter is operating as current generator, that is, when the vehicle decelerates, the motor no longer being supplied with electricity.

Furthermore, when the battery can no longer store current, that document proposes storing the excess energy recovered with the aid of storage means such as a heat accumulator.

However, operation of the electric motor as electric generator acts as an engine brake on the vehicle. For reasons of driving comfort and passenger safety, the engine brake must be controllable and its action limited.

The energy recovered under those conditions must therefore be regulated for reasons of safety of the passengers of the vehicle described above. It is therefore not possible to recover all of the energy that the motor can produce under those conditions.

Furthermore, the energy that the fuel cell can potentially supply with the aid of the surplus reformate produced by the reformer on the drop of demand for electricity of the motor is not exploited.

To solve those problems, this invention proposes a method of the type previously described, characterized in that it comprises the following stages:

a) a balance stage in the course of which the potential electric power that the fuel cell is capable of instantaneously supplying is calculated in accordance with the fuel flow produced by the reformer and in the course of which the electric powers instantaneously consumed by the electric motor and by the equipment are estimated; and

b) a stage of calculation of the excess electric power which is the result of the difference between said potential electric power and the sum of the estimated electric powers consumed; and

c) a stage of determination of the instantaneous electric power storage capacity of the storage means which is released when the excess electric power is strictly positive;

d) a stage of storage which is activated when the instantaneous storage capacity is higher than or equal to the excess electric power, in the course of which the fuel cell is supplied by all of the excess fuel and in the course of which the excess electric power is stored in the storage means;

e) a stage of distribution of the excess fuel, which is activated when the storage capacity is less than the excess electric power, in the course of which the fuel cell is supplied with a portion of the excess fuel sufficient to reconstitute the energy stocks of the storage means.

According to other characteristics of the invention:

the method includes between the stage of calculation b) and the stage of determination c) an intermediate stage of recuperation braking b′) which is activated when the electric power consumed by the electric motor is nil, the electric motor then being capable of operating as electric current generator, and in the course of which the electric power capable of being produced by the electric motor is estimated, then added to said excess electric power;

on storage d) and distribution e) stages, the electric power produced by the electric motor is stored in the storage means in priority over the excess power produced by the fuel cell;

the remaining portion of said excess fuel is burned off;

the remaining portion of said excess fuel is stored in a tank;

the storage means consist of electric batteries;

the storage means consist of a heat accumulator in which the excess electric power is stored in the form of heat energy by means of a compression cooling system;

the storage means consist of a fluid container in which the energy is stored in the form of mechanical energy by means of a pump which modifies the fluid pressure.

The invention further concerns an electric energy recovery system in a motor vehicle driven by at least one electric motor, of the type containing a fuel cell which feeds the electric motor and electrical equipment and is supplied with fuel, and notably hydrogen (H₂), by means of a reformer, the fuel flow of which is controlled in accordance with the electricity consumption (Pₘₒₜ⁻) of the electric motor, and which temporarily produces excess fuel when the consumption (Pₘₒₜ⁻) of the electric motor diminishes, and of the type containing energy storage means, characterized in that it regulates the excess recovered energy produced by the traction motor and the energy supplied by the fuel cell with the aid of the surplus reformate produced by the reformer.

Other characteristics and advantages of the invention will be apparent on reading the detailed description that follows, for the understanding of which the attached figures will be referred to, among which:

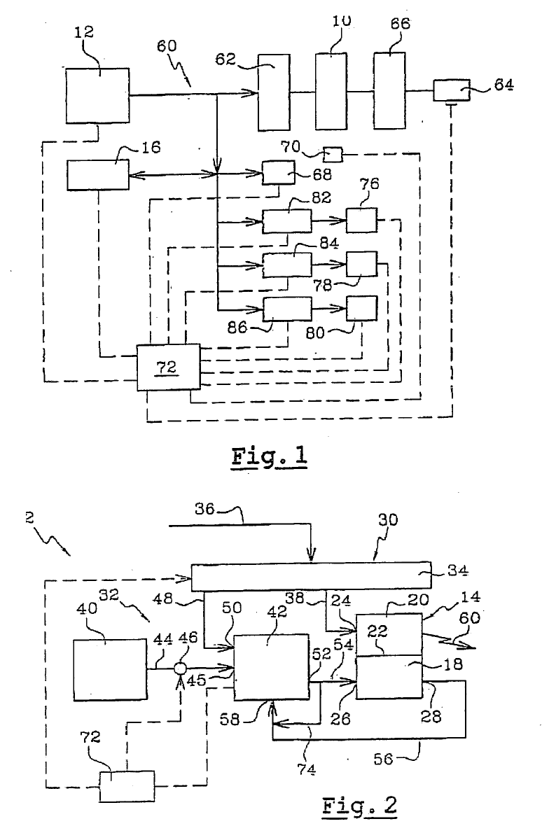

FIG. 1 schematically represents a motor vehicle driven by an electric motor and equipped with an electricity production installation and energy storage means according to the teachings of the invention;

FIG. 2 is a diagram detailing the electricity production installation represented on FIG. 1;

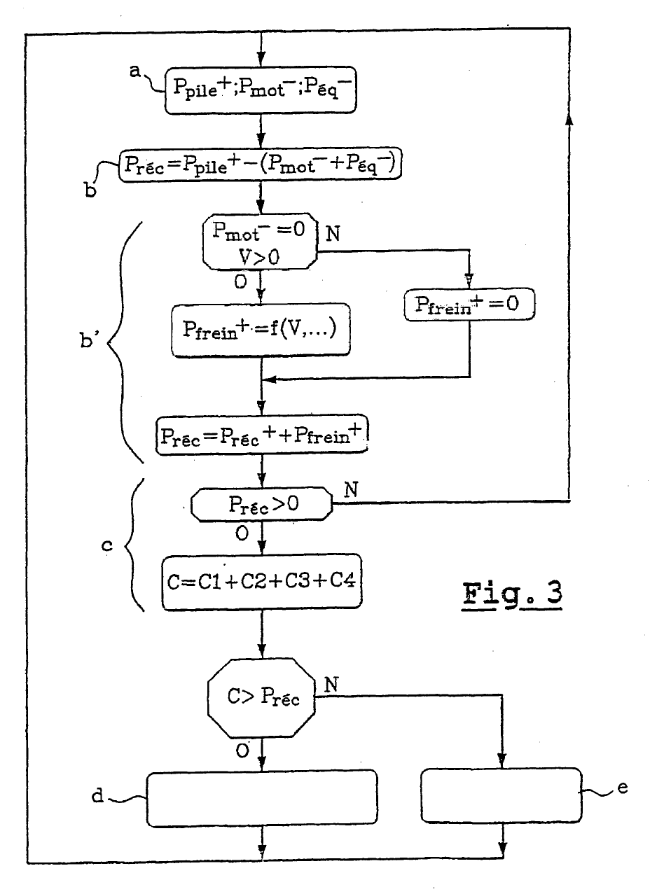

FIG. 3 is a diagram representing the principal stages of the method applied according to the teachings of the invention.

FIG. 1 schematically represents a vehicle driven here by an electric motor 10, which is mainly supplied by an electricity production installation 12 loaded on the vehicle. The electricity production installation 12 notably contains a fuel cell 14, represented on FIG. 2.

The vehicle also contains an auxiliary traction battery 16 which is intended to feed the electricity production installation 12 on operating conditions of the vehicle to be explained in detail in the course of this specification.

We are now going to describe in detail the electricity production installation 12 represented on FIG. 12.

The fuel cell 14 supplies electricity when it is fed with oxidizing agent and fuel.

The fuel cell 14 contains an anode 18 and a cathode 20 which are separated here by a polymer membrane 22 forming an electrolyte.

The cathode 20 contains a cathode feed orifice 24 through which it is supplied with fuel, which is air here.

The anode 18 likewise contains an anode feed orifice 26 through which it is supplied with fuel, which is a reformate here, consisting notably of hydrogen (H₂), and it contains an anode exhaust port 28 through which the residual fuel or reformate is evacuated.

The installation 12 contains a first circuit 30 for feeding the cathode 20 with oxidizing agent, and notably with air, and it contains a second circuit 32 for feeding the anode 18 with fuel, and notably with hydrogen (H₂).

The first circuit 30 for feeding the cathode 20 is composed, notably, of an atmospheric air intake module 34, in which the atmospheric air is admitted via an inlet section 36, and which supplies the cathode 20 with air by means of a cathode feed pipe 38 which is connected to the cathode feed orifice 24. The air intake module 34 is, notably, intended to regulate the flow of air admitted into the cathode 20.

The second circuit 32 for feeding the anode 18 is composed mainly of a tank 40 containing a hydrocarbon such as gasoline, and a reformer 42.

A hydrocarbon feed manifold 44 is connected at a first end to the tank 40 and at a second end to an inlet 45 of the reformer 42. A hydrocarbon pump 46 which is inserted in the hydrocarbon feed manifold 44 is intended to draw the hydrocarbon contained in the tank 40 to the reformer 42. An air feed section 48 is connected at a first end to the air intake module 34 and at a second end to an air inlet 50 of the reformer 42.

The reformer 42 is intended here to extract the hydrogen (H₂) contained in the hydrocarbon. For that purpose, the reformer 42 must, notably, be supplied with air which is routed to the reformer 42 via the air feed section 48.

After extraction of the hydrogen (H₂), it ejects through an outlet 52 a fuel or reformate, containing hydrogen (H₂), in a feed manifold 54 of the anode 18 which is connected to the anode feed orifice 26.

On operation of the fuel cell 14, the anode 18 consumes a portion of the hydrogen (H₂) contained in the reformate, the residual reformate being ejected through the anode exhaust port 28.

The anode exhaust port 28 opens into an anode exhaust manifold 56 which conducts the residual reformate to a feed orifice 58 of a burner (not represented) that is integrated with the reformer 42. The burner is, notably, intended to consume the residual reformate, so as to supply the heat necessary for operation of the reformer 42.

The electricity production installation 12 thus supplies electric energy to an electric circuit 60 of the vehicle, which supplies electricity notably to the electric motor 10 by means of an inverter 62. The electric circuit 60 is represented in solid arrowed lines on FIG. 1.

The electric motor 10 thus supplied converts the electric power received into engine torque which is then transmitted to the wheels 64 of the vehicle by means of a transmission 66.

The electricity production installation 12 also feeds the electrical equipment 68 of the vehicle, such as, for example, the headlights or the windshield wipers.

The electric power supplied by the fuel cell 14 and required for the electric motor 10 and/or for the electrical equipment 68 is capable of varying with the running conditions and/or on the instructions of the driver of the vehicle. The driver has available, in fact, an acceleration control device 70 for the vehicle such as an acceleration pedal.

The electric power supplied by the fuel cell 14 is proportional to the flows of fuel and oxidizing agents injected into the anode 18 and cathode 20. Now, the flow of fuel injected into the anode 18 is produced by the reformer 42.

The vehicle contains an electronic control unit 72 which, on the one hand, therefore controls the flow of air to the cathode 20 by means of an air intake module 34 and, on the other, controls the flow of fuel to the anode 18 by regulating the flow of hydrocarbon by means of the hydrocarbon pump 46, of air and of water admitted into the reformer 42.

The connections between the electronic control unit 72 and the different parts of the vehicle are represented by broken lines on FIGS. 1 and 2.

Thus, when the driver requires greater electric power for the electric motor 10, the electronic control unit 72 controls the air intake module 34 and the hydrocarbon pump 46, so as to adjust the flows of oxidizing agent and fuel to the electric power production required.

However, the reformer 42 can respond to that command only after a not negligible latency time, which is, for example, on the order of a few seconds. In fact, the electronic control unit 72 commands the hydrocarbon, air and water flows which are admitted into the reformer 42. The latency time is the time necessary for the reformer 42 to convert the hydrocarbon, air and water into reformate. Thus, the variation of the hydrocarbon flow by the electronic control unit 72 is reflected on the flow of fuel on outlet from the reformer 42 only once the latency time has elapsed. During that latency time and when the electronic control unit 72 requires a drop in fuel flow, the reformer 42 continues to produce surplus fuel.

The electricity production installation 12 therefore contains a by-pass 74 of the surplus fuel, which is connected at its first end to the cathode feed pipe 38 and which is connected at its second end to the burner of the reformer 42. That by-pass 74 is notably intended to deflect the surplus fuel directly to the burner, so that the surplus fuel will be burned off.

Furthermore, the auxiliary traction battery 16 is intended to supply the electric power production installation 12 temporarily, when the electric motor 10 requires an increase in electric power. The auxiliary battery 16 is electrically connected to the electric motor 10 as well as to the electrical equipment 68 by means of the electric circuit 60.

In addition to the electricity normally supplied by the electricity production installation 12, depending on the instantaneous electric energy need of the vehicle, the vehicle can temporarily supply surplus electric energy.

Thus, the electric motor 10 of the vehicle is capable of operating as an electric current generator when the vehicle is in deceleration phase and the electric motor 10 is not supplied with electric current. The motor which is then driven in rotation by the wheels 64 via the transmission 66 can then supply electric current.

However, the production of electric energy by the electric motor 10 acts on the vehicle as a brake. In order not to catch the driver by surprise and to render deceleration of the vehicle predictable, operation of the electric motor 10 as a generator is therefore regulated by the electronic control unit 72.

The surplus fuel produced by the reformer 42, when the electric power required for the motor is low, is traditionally intended to be directly reinjected into the reformer 42 in order to be burned off. However, the invention proposes a method for recovering at least a part of the energy that the fuel cell 14 is capable of supplying with this surplus fuel.

In the remainder of the specification the electric power which is capable of being supplied in the vehicle, but is not instantaneously consumable by the electric motor 10 and/or the electrical equipment 68, will be described as “recovered” electric power.

The vehicle contains different devices which are capable of storing the recovered electric energy in different forms.

In this embodiment the vehicle contains, notably, a heat accumulator 76, a pressure accumulator 78, a vacuum accumulator 80 and the auxiliary traction battery 16.

The storage of electric energy in a heat accumulator 76 is, notably, described and represented in French patent application No. 01-01720. The heat accumulator 76 forms part here of an air conditioning system (not represented) of the vehicle. The electric energy recovered is used notably to operate a compressor 82 of the air conditioning system which, instead of cooling the passenger space of the vehicle, cools the heat accumulator 76. The cold thus stored is intended to be used subsequently by the air conditioning system, which then needs less electric energy to operate.

The pressure accumulator 78 is integrated here with an assisted steering system (not represented) comprising, notably, a hydraulic electropump group 84. The electricity recovered is used here to operate the electropump 84, which compresses a fluid contained in the pressure accumulator 78. The electric energy is thus converted into mechanical energy, which is stored in the pressure accumulator 78.

The vacuum accumulator 80 is integrated here with a braking assistance system (not represented) of the vehicle, which comprises a vacuum pump 86. The electricity recovered is used to feed the vacuum pump 86, which sucks in a fluid contained in the vacuum accumulator 80. The electric energy is thus converted into mechanical energy, which is stored in the vacuum accumulator 80.

The electricity recovered is thus capable of being stored directly in the auxiliary traction battery 16.

We are now going to describe in detail the method of energy recovery and storage according to the teachings of the invention, with reference to FIG. 3 and making use of the parts of the vehicle previously described.

The method mainly comprises the following stages:

a) a balance stage in the course of which the potential electric power Pₚᵢₗₑ⁺ [P_{cell}⁺] that the fuel cell 14 is capable of instantaneously supplying is calculated in accordance with the fuel flow produced by the reformer 42 and in the course of which the electric powers instantaneously consumed by the electric motor 10 Pₘₒₜ⁻ and by the equipment 68 P_{eq}⁻ are estimated; and

b) a stage of calculation of the recoverable or excess electric power P_{rec} which is the result of the difference between said potential electric power Pₚᵢₗₑ⁺ and the sum of the estimated electric powers consumed (Pₘₒₜ⁻+P_{eq}⁻); and

b′) an intermediate stage of recuperation braking which is activated when the electric power consumed by the electric motor 10 Pₘₒₜ⁻ is nil, the electric motor 10 then being capable of operating as electric current generator, and in the course of which the electric power capable of being supplied by the electric motor 10 P_{frein}⁺ [P_{brake}⁺] is estimated, then added to said recoverable excess electric power P_{rec};

c) a stage of determination of the instantaneous electric power storage capacity C of the storage means which is released when the excess electric power P_{rec} is strictly positive;

d) a stage of storage which is activated when the instantaneous storage capacity C is higher than or equal to the excess electric power P_{rec}, in the course of which the fuel cell 14 is supplied by all of the excess fuel and the excess electric power P_{rec} is stored in the storage means;

e) a stage of distribution of the excess fuel, which is activated when the storage capacity C is less than the excess electric power P_{rec}, in the course of which the fuel cell 14 is supplied with a portion of the excess fuel sufficient to reconstitute the energy stocks of the storage means.

On stage a) of the method, the instantaneous electric power Pₚᵢₗₑ⁺ that the fuel cell 14 is capable of delivering from the instantaneous fuel flow supplied by the reformer 42 is estimated and memorized by the electronic control unit 72. The fuel flow is, for example, measured by an appropriate sensor which is situated at the outlet of the reformer 42, the measurement then being transmitted to the electronic control unit 72.

The instantaneous electric power consumed Pₘₒₜ⁺ by the electric motor 10 is also estimated and memorized by the electronic control unit 72, for example, from the position of the acceleration pedal 70 worked by the driver.

Finally, the instantaneous electric power consumed P_{eq}⁻ by the electrical equipment 68 of the vehicle is estimated and memorized by the electronic control unit 72 from measurements made by different sensors (not represented), which are then sent to the electronic control unit 72 by means of electric connections.

Then, on the stage of calculation b) of the method, the recoverable or excess electric power P_{rec}, which is the result of the difference between the potential electric power Pₚᵢₗₑ⁺ and the sum of the estimated electric powers consumed (Pₘₒₜ⁻+P_{eq}⁻) is calculated by the electronic control unit 72 from those three types of memorized values.

The excess electric power P_{rec} is, in fact, the electric power that the vehicle is capable of recovering from the surplus fuel produced by the reformer 42.

If the value calculated is less than or equal to zero, the reformer 42 does not supply excess fuel and the fuel cell 14 is, therefore, not capable of supplying recoverable electric energy.

On the other hand, if the value calculated is higher than zero, the reformer 42 does supply excess fuel and, therefore, excess electric energy is capable of being supplied to the vehicle by the fuel cell 14.

According to this embodiment of the invention, whatever the result of stage b), it is necessary to determine if the vehicle is capable of producing energy by recuperation braking.

If the electric power required for the electric motor 10 Pₘₒₜ⁻ is nil and the speed V of the vehicle is strictly higher than zero, the vehicle is in a situation of recuperation braking. The intermediate stage b′) is, therefore, engaged by the electronic control unit 72 in order to estimate the recoverable electric power in a situation of recuperation braking P_{frein}⁺.

Otherwise, the vehicle is considered not in a situation of recuperation braking and stage c) is directly engaged by the electronic control unit 72.

On intermediate stage b′), the electric power P_{frein}⁺ that the electric motor 10 is capable of supplying on recuperation braking is estimated by the electronic control unit 72. That estimate takes into account the speed V of the vehicle, as well as the ergonomics and passenger comfort. That estimated power P_{frein}⁺ is then added to the recoverable power P_{rec} previously calculated. That sum then constitutes the new value of recoverable power P_{rec} by the vehicle.

Then, on stage c), a test is carried out by the electronic control unit 72 to determine whether the electric energy is capable of being recovered in the vehicle. Thus, if the recoverable power P_{rec} is strictly higher than a threshold that is at zero value here, the electronic control unit 72 engages the continuation of stage c). Otherwise, there is no electric energy to be recovered, and the electronic control unit 72 interrupts and, therefore, reinitializes the process.

The instantaneous energy storage capacity on the vehicle is determined by the electronic control unit 72.

During that stage the electric power Cl which can be charged in the auxiliary traction battery 16 is calculated by the electronic control unit 72 on the basis, for example, of the charge state of the battery 16 and its temperature.

If the air conditioning system is activated by the driver, but the air conditioning compressor is off, and if the heat accumulator 76 has not reached a minimum temperature threshold, then the electric power C2 required by the compressor 82 of the air conditioning system, in order to cool the heat accumulator 76 to the minimum temperature threshold, is calculated by the electronic control unit 72.

If the pressure inside the vacuum accumulator 80 is higher than a maximum pressure threshold, the electric power C3 required by the vacuum pump 86 in order to lower the pressure in the vacuum accumulator 80 to the minimum pressure threshold is calculated by the electronic control unit 72.

If the pressure inside the pressure accumulator 78 is lower than a minimum pressure threshold, the electric power C4 required by the electropump 84 in order to raise the pressure inside the pressure accumulator 78 to the maximum pressure threshold is calculated by the electronic control unit 72.

The instantaneous energy storage capacity C on the vehicle is equal to the sum of these electric powers (C1+C2+C3+C4).

Finally, the instantaneously recoverable electric power P_{rec} is compared by the electronic control unit 72 with the instantaneous storage capacity C.

If the storage capacity C is higher than the recoverable power P_{rec}, then the storage stage d) is engaged. The electronic control unit 72 controls charging of the energy stocks 16, 76, 78, 80 by using the electric energy supplied by the electric motor 10 and by feeding the fuel cell 14 with all of the surplus fuel.

Otherwise, the distribution stage e) is engaged. According to this embodiment of the invention, the electronic control unit 72 controls distribution of the electric power P_{frein}⁺ supplied by the electric motor 10 in the different energy storage areas of the vehicle 16, 76, 78, 80.

Then, if the instantaneous storage capacity C is still higher than zero, the electronic control unit 72 controls the supply of the fuel cell 14 with the quantity of fuel necessary to completely recharge the energy stocks, the rest of the surplus fuel being directly routed to the reformer 42 by means of the by-pass 74 in order to be burned off there.

Otherwise, the surplus fuel is totally routed to the reformer 42 by means of the by-pass 74 in order to be burned off there.

At the end of a process cycle, all of the values are reinitialized to zero and the process is repeated until the vehicle comes to a total stop.

According to another embodiment of the invention not represented, the surplus fuel routed by the by-pass 74 is conducted to a temporary fuel storage tank.

1-9. (canceled)

10. An electric energy recovery system in a motor vehicle driven by at least one electric motor, containing a fuel cell that feeds the electric motor and electrical equipment supplied with fuel of hydrogen, by a reformer, a fuel flow of which is controlled in accordance with electricity consumption of the electric motor, and which temporarily produces excess fuel when consumption of the electric motor diminishes, and containing an energy storage,
the method comprising:
a) a balancing during which a potential electric power that the fuel cell is capable of instantaneously supplying is calculated in accordance with the fuel flow produced by the reformer and during which electric powers instantaneously consumed by the electric motor and by the equipment are estimated;
b) calculating excess electric power which is the result of a difference between the potential electric power and a sum of the estimated electric powers consumed;
c) determining instantaneous electric power storage capacity of the energy storage which is released when the excess electric power is strictly positive;
d) a storing activated when the instantaneous storage capacity is higher than or equal to the excess electric power, during which the fuel cell is supplied by all of the excess fuel and during which the excess electric power is stored in the energy storage;
e) distributing the excess fuel, which is activated when the storage capacity is less than the excess electric power, during which the fuel cell is supplied with a portion of the excess fuel sufficient to reconstitute energy stocks of the energy storage.

11. A method according to claim 10, further comprising, between the calculating b) and the determining c), recuperation braking b′) activated when the electric power consumed by the electric motor is nil, the electric motor then being capable of operating as an electric current generator, and during which the electric power capable of being produced by the electric motor is estimated and then added to the excess electric power.

12. A method according to claim 11, wherein on the storing d) and distributing e) the electric power produced by the electric motor is stored in the energy storage in priority over the excess power produced by the fuel cell.

13. A method according to claim 10, wherein a remaining portion of the excess fuel is burned off.

14. A method according to claim 10, wherein a remaining portion of the excess fuel is stored in a tank.

15. A method according to claim 10, wherein the energy storage includes electric batteries.

16. A method according to claim 10, wherein the energy storage includes a heat accumulator in which the excess electric power is stored in a form of heat energy by a compression cooling system.

17. A method according to claim 10, wherein the energy storage includes a fluid container in which the energy is stored in a form of mechanical energy by a pump that modifies fluid pressure.

18. An electric energy recovery system in a motor vehicle driven by at least one electric motor, comprising:
a fuel cell that feeds the electric motor and electrical equipment and is supplied with fuel hydrogen, by a reformer, a fuel flow of which is controlled in accordance with electricity consumption of the electric motor, and which temporarily produces excess fuel when the consumption of the electric motor diminishes, and containing an energy storage,
the system regulating excess recovered energy produced by the motor and energy supplied by the fuel cell with aid of surplus reformate produced by the reformer.
